(19) United States
(12) Patent Application Publication
(10) Pub. No.: US 2010/0058635 A1
(43) Pub. Date: Mar. 11, 2010

(54) WIND DEFLECTABLE SIGN-STAND

(75) Inventors: Michael KNAPP, Elmira, NY (US); Stephen T. ZIMAR, Elmira, NY (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: EASTERN METAL OF ELMIRA, INC., Elmira, NY (US)

(21) Appl. No.: 12/554,233

(22) Filed: Sep. 4, 2009

Related U.S. Application Data
(60) Provisional application No. 61/094,633, filed on Sep. 5, 2008.

(51) Int. Cl. F16M 11/02; F16M 11/24

(52) U.S. Cl. 40/607.01

(57) ABSTRACT

A wind deflectable sign-stand includes a base, a mast for mounting a sign, and first and second polymeric resilient support members connecting the mast to the base. The mast has first and second mast members, and a breakaway member including a first end and a second end and being operably connected to the first and second mast members. The sign-stand is configured such that, upon sufficient impact, the breakaway member will fracture, thereby separating the first end and the second end. Such separation of the first end and the second end occurs along a breakaway section of the breakaway member, and the breakaway section defines a first acute angle with respect to a plane perpendicular to a longitudinal direction of the breakaway member.

### CROSS-REFERENCE TO RELATED APPLICATIONS

The present application claims priority to U.S. Provisional Patent Application No. 61/094,633, which was filed on Sep. 5, 2008, the contents of which are incorporated by reference herein in their entirety.

### BACKGROUND OF THE INVENTION

The present invention relates generally to a wind deflectable sign-stand used for supporting signs and display devices of all kinds. The invention more particularly relates to a wind deflectable sign-stand having a pair of laterally spaced resilient mast supports and a breakaway mast for supporting signs, particularly temporary road signs, that are subject to high wind loading and may be struck by motor vehicles around construction sites or roadways.

There are numerous sign-stands and poster display devices known today which are used for displaying various signs and messages for advertisement and to convey information to the public. On construction sites, the signs are typically positioned on posts or sign-stands which are either anchored in the ground or held in place by a base supported by sandbags or other heavy objects. However, natural winds or airflow gusts created by passing traffic impact large planar signs and can topple the sign and base, or break the sign from the base.

Sign stands are known that provide a resilient member between the sign and the base such that the sign can move or tilt with respect to the base to deflect the wind force. U.S. Pat. No. 4,309,836, for example, discloses a wind deflectable sign holder where the mast is mounted to the base through a resilient strip that allows the mast to bend or tilt with respect to the base. However, the resilient strip does not prevent the mast from twisting when the wind force impacts the sign at an angle, making the sign difficult to read and subjecting the mast to bending or breaking if the mast twists sufficiently relative to the base.

Sign stands having two spaced apart helical or coil springs are known to allow the sign to bend or tilt relative to the base while helping to resist a torsional force on the sign. U.S. Pat. Nos. 3,646,696 and 4,288,053, for example, disclose a spring mounted sign-stand that has a mast mounted to the base through a pair of laterally spaced helical or coil springs. However, the helical or coil springs fatigue and eventually fail after continued flexures and the resistant force required to bend the springs also decreases as the length of the coil spring expands, or bends over under tensile stress. Additionally, the attachment methods for mounting the coil springs to the base make it difficult or impractical to interchange coil springs that have different resilient properties that may be desired based on prevailing wind conditions, the type of sign displayed and/or the purchaser's unique specifications.

While a resilient strip may be used to help deflection of a sign exposed to heavy winds (see U.S. Pat. No. 4,309,836), such structure may not have as much torsional resistance as other designs.

Further, many of the portable signs found on construction sites are placed in temporary locations that are directly adjacent to, or otherwise accessible from, the roadway, which subjects the portable sign to potential impacts from automobiles and other roadway traffic. A common problem with this type of design is that when struck by a vehicle, the stand does not break cleanly and in a predictable manner, making it difficult to predetermine where, and with what force, the sign or sign-stand will fall when hit by the impacting vehicle. This is especially problematic with wood, metal, and some plastic signs that are heavier and more rigid, and which can cause substantial vehicle and sign damage when struck, as well as with signs that extend higher from the ground. U.S. Patent Application Publication No. 2003/0183740 discloses a sign stand that has a horizontal break in the mast close to the base, forming two mast segments. The two mast segments are held together with an internal core. The internal core will break prior to breakage of the upper mast segment such that upon impact, the core breaks and the sign falls in a predictable manner relative to the impact direction. Providing a predetermined breaking point is preferred over a single piece mast that may fracture above the height of the vehicle such that the sign falls into or toward the vehicle's passenger compartment. However, it is possible that under sufficiently strong winds, that the internal core may break. It is therefore desirable to increase the strength that the internal core may have against strong winds.

### BRIEF SUMMARY OF THE INVENTION

The present invention, in one embodiment, is directed to a wind deflectable sign-stand comprising a base, a mast for mounting a sign, and first and second resilient support members connecting the mast to the base. The support members each comprise a polymer.

Another aspect of the present invention is a sign-stand comprising first and second mast members and a breakaway member comprising a first end and a second end and being operably connected to the first and second mast members. The sign-stand is configured such that, upon sufficient impact, the breakaway member will fracture therethrough, thereby separating the first end and the second end. Such separation of the first end and the second end occurs along a breakaway section of the breakaway member, and the breakaway section defines a first acute angle with respect to a plane perpendicular to a longitudinal direction of the breakaway member.

### BRIEF DESCRIPTION OF THE DRAWINGS

The following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a front elevational view of a sign-stand in accordance with an embodiment of the present invention;

FIG. 1A is a front elevational view of the sign-stand shown in FIG. 1 with the sign removed and showing a sign-holder for a flexible batten type sign (not shown) instead of clips;

FIG. 2 is a side elevational view of the sign-stand shown in FIG. 1A;

FIG. 3 is an enlarged view of the base of the sign-stand shown in FIG. 1;

FIG. 4 is a side elevational view of the sign-stand base shown in FIG. 3;

FIG. 5 is a cross sectional view of a first support member of the sign-stand shown in FIG. 1 taken along line 5-5 in FIG. 3;

FIG. 6 is an enlarged exploded view of the mast and breakaway member of the sign-stand of FIG. 1;

FIG. 7 is a perspective view of the breakaway member of FIG. 6 installed in a second mast member with the first mast member removed; and

FIG. 8 is a perspective view of another embodiment showing a breakaway member installed in a second mast member with the first mast member removed.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the sign-stand and designated parts thereof. Unless specifically set forth herein, the terms “a”, “an” and “the” are not limited to one element but instead should be read as meaning “at least one”. The terminology includes the words noted above, derivatives thereof and words of similar import.

The present invention is directed to a sign stand that has a mast attached to a base with at least two resilient supports that increase in strength as they bend, and which resist torsional forces. Such sign stand has a breakaway beam that provides, upon impact, a clean predetermined break between segmented mast portions, and which is also able to withstand substantial and continuous high wind loads without breaking.

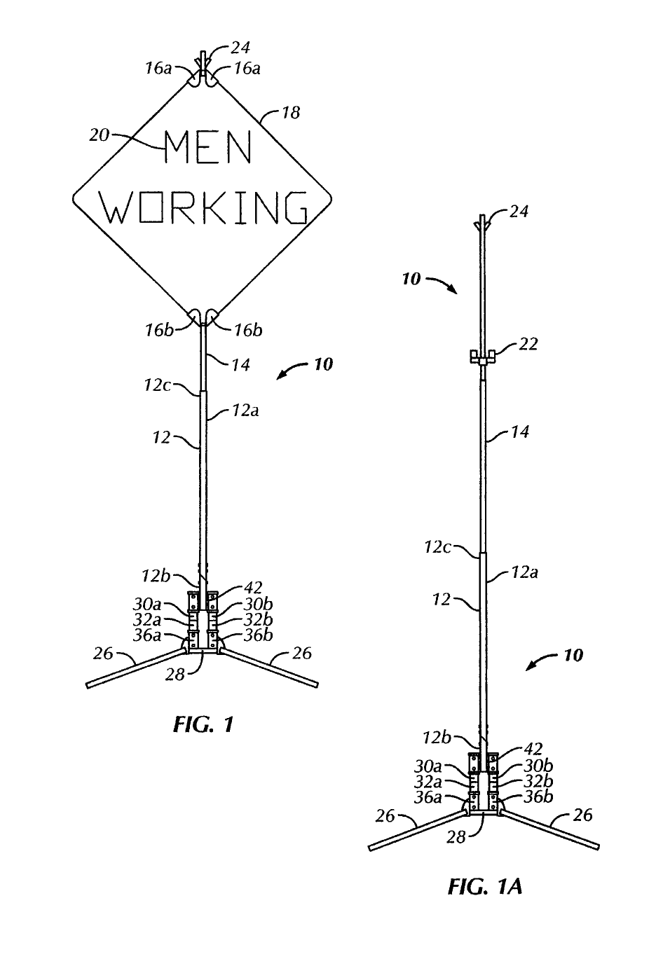

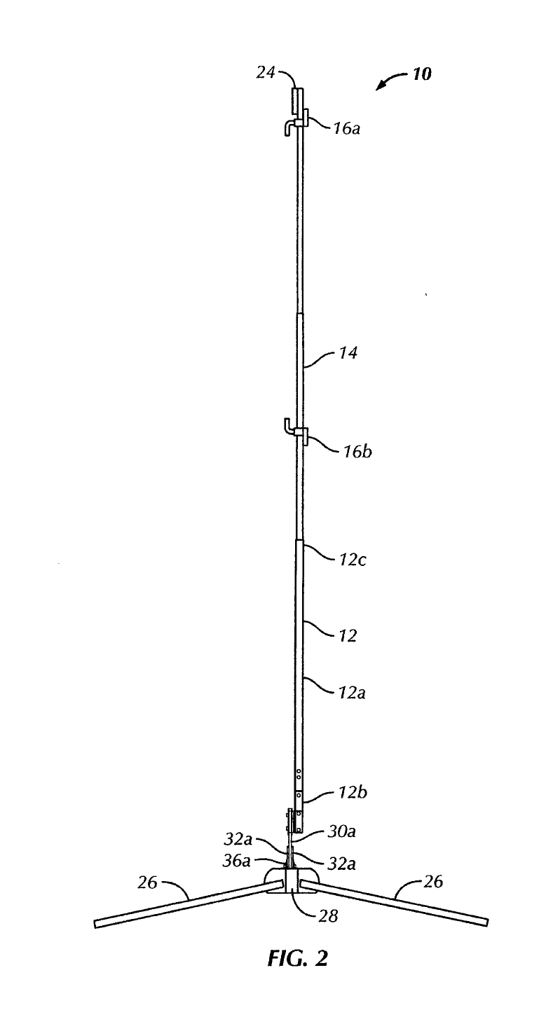

Referring FIGS. 1-4, wherein like numerals indicate like elements throughout, there is shown a sign-stand 10, in accordance with a preferred embodiment of the present invention. The sign-stand 10 includes a vertically extending mast 12 which includes first and second mast members 12a, 12b. A sign support 14 extends from a top end 12c of the first mast member 12a. The sign support 14 may have multiple parts including a first and second sign clips 16a, 16b (FIGS. 1 and 2) and a flat panel or sign 18. The sign 18 may be rigid or flexible. When the sign 18 is flexible (not shown), the sign 18 may be made of either fabric or flexible polymeric material with a warning symbol or message on one side, and a pair of crossed battens on the other side. With a flexible sign 18, a sign-holder 22 is used to fix the flexible sign to the sign support 14. When the sign 18 is rigid, as shown in FIG. 1, the sign 18 may be made of metal or wood or a rigid polymeric material with a warning symbol or message 20 on one side and sign clips 16a, 16b to attach the sign 18 to the sign support 14 in a conventional manner. FIG. 1A includes sign-holder 22 instead of clips 16a, 16b.

At the top of the sign support 14 may be one or more warning flags (not shown) held in place by a bracket 24. The sign clips 16a, 16b are preferably movably mounted along the length of the sign support 14 to adjust for differently sized signs 18. For example, the sign clips 16a, 16b may be mounted by screws or bolts that can be temporarily disengaged from the sign support 14 to be movable along the length of the sign support 14 before re-engagement with the sign support 14. Additionally, the sign support 14 may be telescopically mounted or otherwise moveable to adjust the height at which the sign 18 is spaced from a support surface or ground (not shown) and or to adjust for the size of the sign 18. The second sign clip 16b and/or the sign-holder 22 is preferably adjustable to allow variable distances between the bottom of the sign and the ground. As is commonly known in the construction industry, the sign 18 and flags are used as a warning for approaching traffic. However, the present sign-stand 10 can be used with any type of sign 18 or sign support 14 and the sign 18 may be positioned at any suitable required height.

The mast 12 is supported on the ground by a plurality of legs 26 pivotably mounted to a base 28. The legs 26 are preferably pivotably mounted to the base 28 such that the legs 26 pivot from an extended position (shown) where the legs 26 are generally perpendicular to the mast 12 but at a slight angle to the ground such that the base 28 is spaced from the ground, to a folded position (not shown) where the legs 26 are pivoted upwardly to be generally parallel with the mast 12 such that the sign-stand 10 can be more compactly moved and stored. The base 28 is preferably spaced from the ground to ensure that all of the legs 26 touch the ground. The legs 26 may have a spring biased shaft (not shown) or other latching mechanism that can be depressed or selectively released by a user to pivot the legs 26 with respect to the base 28. The legs 26 are typically comprised of aluminum tubing having a polymeric end cap (not shown) but the legs 26 may be comprised of any generally rigid material. The base is preferably comprised of a heavy, rigid material, such as a steel or a reinforced polymeric material, to aid in stabilizing the base 28 and preventing tipping of the sign-stand 10, but the base 28 may be comprised of any high strength, generally rigid material. The base 28 and legs 26 are well known to those of ordinary skill in the art. Accordingly, further description thereof is omitted for purposes of brevity and is not limiting.

Referring to FIGS. 1-5, the mast 12 is connected to the base 28 through laterally spaced first and second resilient support members 30a, 30b. The support members 30a, 30b allow the mast 12, sign support 14 and sign 18 to deflect downwardly when subjected to wind loading and then return to the normal upright position as shown in FIG. 1. The support members 30a, 30b are preferably shaped as elongated bodies having a rectangular cross-sectional shape with a width substantially greater than a thickness. The width direction is preferably generally parallel to the major plane of the sign 18 because the wind force exerted on the sign 18 is strongest in a direction generally perpendicular to the sign 18, and such position of the support members 30a, 30b, enables deflection when wind force exertion is strongest. However, the support members 30a, 30b may be of any suitable cross-sectional shape, such as circular (resulting in an elongated cylindrical shape) and the support members 30a, 30b may or may not be hollow. The support members 30a, 30b are preferably comprised of 60%-80% polymeric material, such as a polyester, and 20%-40% reinforcing longitudinally extending fibers 35, such as fiberglass fibers 35 (see FIG. 5). More preferably, the support members 30a, 30b comprise 80% polymeric material and 20% reinforcing fibers 35. However, it is within the spirit and scope of the present invention that the support members 30a, 30b may be comprised of other resilient materials. The support members 30a, 30b are preferably resilient in a direction generally perpendicular to their longitudinal length and the support members 30a, 30b preferably have an increasingly resistant stiffness as the support members 30a, 30b are bent. Though it is preferred that there be two resilient support members 30a, 30b, it is within the spirit and scope of the present invention that there may be more than two (i.e., three, four, or more) resilient support members 30a, 30b such that a torsional force on the mast 12 is sufficiently resisted.

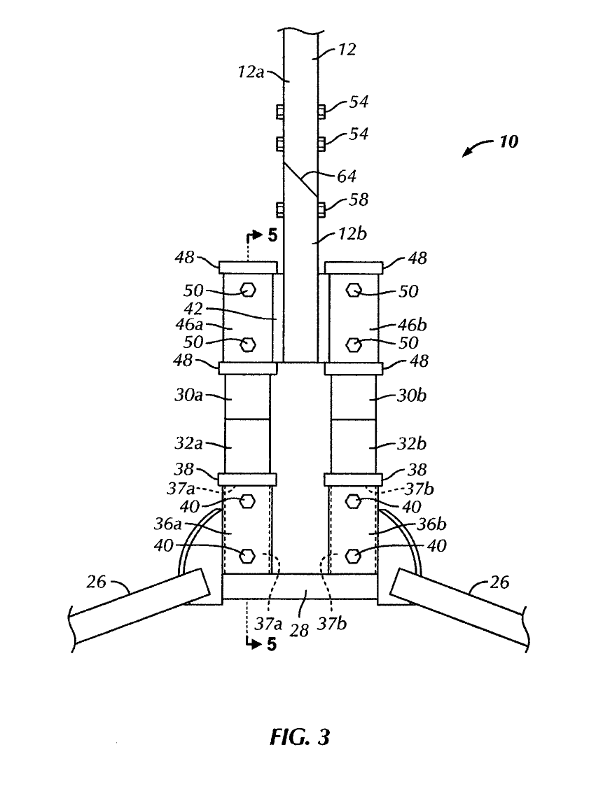

Referring specifically to FIGS. 3, 4, and 5, the support members 30a, 30b are preferably sandwiched and reinforced between a pair of third resilient support members 32a and a pair of fourth resilient support members 32b, respectively. The third and fourth support members 32a, 32b are preferably comprised of a similar material as the first and second support members 30a, 30b but may be comprised of any resilient or non-resilient material. Though the third and fourth support members 32a, 32b are preferably separate components, the third and fourth support members 32a, 32b may be integrally formed with the first and second support members 30a, 30b such that the first and second support members 30a, 30b have a thicker cross sectional base. Additionally, though the third and fourth support members 32a, 32b are preferably provided toward a bottom end 30c of the first and second support members 30a, 30b, the third and fourth support members 32a, 32b may be provided alternatively or additionally toward a top end 30d of the first and second support members 30a, 30b. The third and fourth support members 32a, 32b preferably each include rounded interior top edges 34 that allow smooth flexure of the first and second support members 30a, 30b without otherwise causing stress concentrations on the first and second support members 30a, 30b by sharpened corners of the third and fourth support members 32a, 32b.

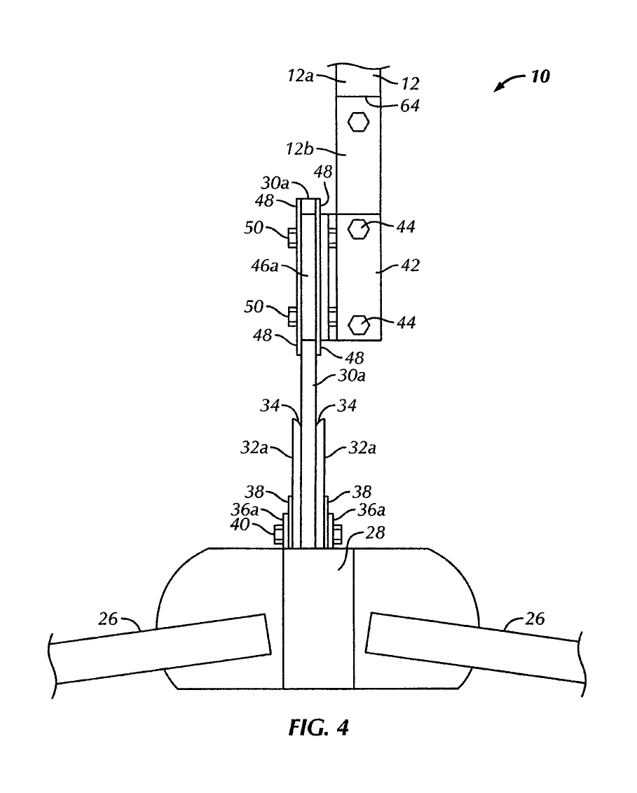

The base 28 preferably has two laterally spaced apart first and second support structures 36a, 36b, configured to define first and second receiving slots 37a, 37b, respectively, for receiving and holding the bottom ends 30c of the first and second support members 30a, 30b, respectively, and larger portions of the third and fourth support members 32a, 32b, respectively. First plates 38 are provided on each laterally extending side of the third and fourth support members 32a, 32b (a laterally extending side extends along the width of the third and fourth support members 32a, 32b). The first plates 38 are preferably provided adjacent to the edges of the receiving slots 37a, 37b to reduce stress on the third and fourth support members 32a and 32b caused by the edges of the receiving slots 37a, 37b. A pair of spaced apart first bolts 40 (FIGS. 3 and 4) extend through each of the support structures 36a, 36b and retain the first, second, third and fourth support members 30a, 30b, 32a, 32b and the plates 38 in the respective receiving slots 37a, 37b.

The mast 12 includes a mounting member 42 attached to the mast 12 with a pair of second bolts 44. The mounting member 42 has first and second enclosing structures 46a and 46b, respectively, which define first and second mounting slots 47a, 47b, respectively. The mounting slots 47a, 47b, are laterally spaced from one another and align with the receiving slots 37a, 37b, respectively. The mounting slots 47a, 47b receive and hold the top end 30d of the first and second support members 30a, 30b (FIG. 5). A second plate 48 is provided on each laterally extending side of the first and second support members 30a, 30b to reduce stress caused by the edges of the mounting slots 47a, 47b. The second plates 48 are positioned proximate to openings of the mounting slots 47a and 47b. A pair of third bolts 50 (FIGS. 3 and 4) extend through each of the enclosing structures 46a, 46b and retain the first and second support members 30a, 30b and the second plates 48 in their respective mounting slots 47a, 47b. The first, second, third and fourth support members 30a, 30b, 32a, 32b and the first and second plates 38, 48 are preferably secured to their corresponding receiving slots 37a, 37b or mounting slots 47a, 47b with bolts 40, 50 to allow for easy assembly and replacement though it is understood that any type of fastener or securement could be used such as pins, screws, nails, rivets, staples, dogs, dowels, epoxy, cement, snap grooves, key-ways, threaded fittings, couplings, spring tension devices, welds, or the like. Additionally, the first and second plates 38, 48 are preferably comprised of a polymeric material such as polyethylene but may be comprised of any suitable material. The mounting and receiving slots 37a, 37b, 47a, 47b are shown to have open lateral sides (FIGS. 3 and 4) but the mounting and receiving slots 37a, 37b, 47a, 47b may have closed lateral sides to form generally tubular structures.

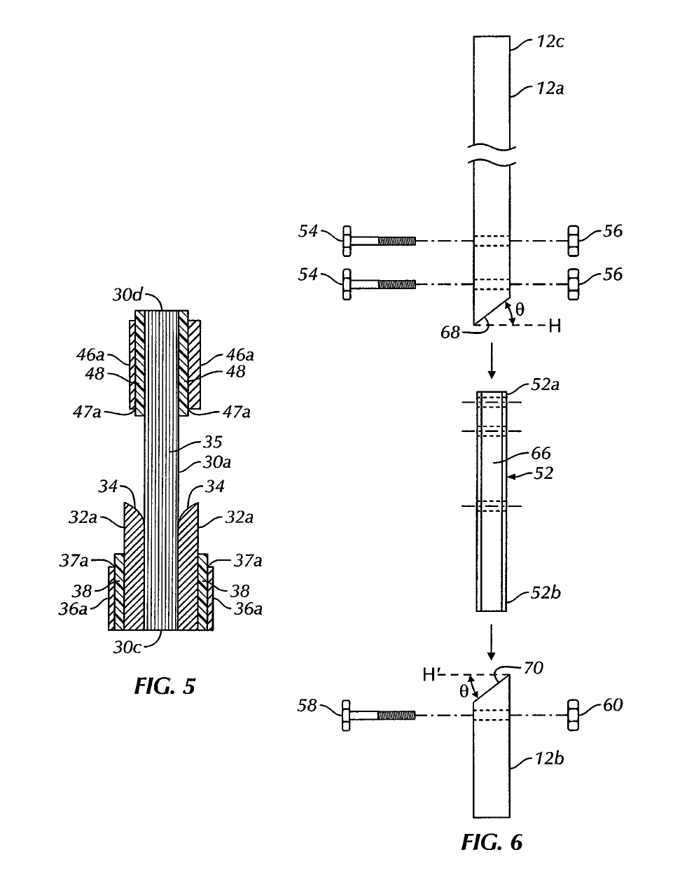

Referring specifically to FIGS. 6-8, the mast 12 includes a breakaway member such as a breakaway beam 52. The breakaway beam 52 is positioned inside the mast 12 and a first end 52a of the breakaway beam 52 extends into the first mast member 12a and a second end 52b of the breakaway beam 52 extends into the second mast member 12b. The first and second mast members 12a, 12b include first and second angled surfaces 68 and 70, respectively, which are adjacent to each other (and, most preferably, adjoin each other) proximate to a breakaway section 66 of the breakaway beam 52. Preferably, the position of the first and second surfaces 68 and 70 define the breakaway section 66 so that the breakaway section 66 is preferably between the first and second mast members 12a, 12b. The adjoining of the first and second surfaces 68, 70 define an angle θ relative to planes which are perpendicular to the longitudinal direction of the breakaway beam 52, such as planes H, H′ (see FIG. 6). The first and second mast members 12a, 12b, preferably adjoin each other (via first and second surfaces 68 and 70) at a breakaway line 64 on the breakaway section 66 of the breakaway beam 52. Preferably, the breakaway line 64 forms part of the plane H′ and is the vertex of angle θ from the plane H′. Breakaway line 64 may be an imaginary line, or it may be a small groove (continuous or discontinuous) to facilitate the breakage of the breakaway beam at breakaway line 64. The presence of breakaway line 64 as a groove would preferably be sufficiently small to avoid breakage of the sign by high winds, as opposed to a collision, for example, with a motor vehicle. The angle θ is preferably forty-five degrees from planes H, H′, but the angle θ may be more than zero degrees and less than ninety degrees. An increase in angle θ increases the cross sectional area of the breakaway beam 52 that must be broken compared to a cross sectional area taken perpendicular to the longitudinal length of the breakaway beam 52 (i.e. θ,=0), which increases the tolerance to high winds.

The first and second surfaces 68, 70 preferably are complimentarily shaped and face one another. However, the shapes may have some slight variations from one another and the angle defined by first surface 68 may be slightly different from the angle defined by second surface 70 as long as the breakage of the breakaway beam 52 is at an angle relative to planes H, H′. When the first surface 68 and the second surface 70 have slightly different shapes, the angle θ can still be defined by adjoining the first and second surfaces 68 and 70 in which the position of a plane positioned at angle θ can be approximately between first surface 68 and second surface 70. Also, angle θ can be an approximation of the contact portions between the first and second surfaces 68 and 70, and does not have to be exact. Preferably, a breakage angle θ′ relative to planes H, H′ is the same as the angle θ defined by first and second surfaces 68, 70. However, θ and θ′ may be approximately or substantially the same as one another. The angles θ and θ′ can be, independently, from zero (preferably more than zero) to less than ninety degrees. For example, the angles θ and θ′ may be five to eighty five degrees, or ten degrees to eighty degrees, or thirty five degrees to fifty five degrees, or forty degrees to fifty degrees, but are preferably acute angles, such as one degree to forty five degrees, or five degrees to forty five degrees, or ten degrees to forty degrees, or fifteen degrees to thirty five degrees, or twenty degrees to thirty degrees. Any range between zero degrees and ninety degrees is within the scope of the present invention and, especially, any range that is above zero and up to 45 degrees is within the scope of the present invention.

Upon impact by, for example, a motor vehicle (not shown), the motor vehicle hits the first mast member 12a, the sign support 14 and/or the sign 18, and the breakaway beam 52 is preferably fractured through the break line 64 at the breakaway section 66 proximate to where the first and second mast members 12a, 12b adjoin. Such fracture of the breakaway beam 52 is preferably along a plane at breakage angle θ′from planes such as H and H′ along the breakaway section 66. Angle θ′ may be defined by a plane positioned at angle θ′ with respect to planes perpendicular to the longitudinal direction of the breakaway beam 52, such as planes H, H′. Just like angle θ, angle θ′ can be an approximation. Thus, angle θ′ can be an approximate angle of the breakage of the breakaway beam 52 relative to planes such as H, H′. The breakage of the breakaway beam 52 at an angle allows the first mast member 12a, the sign support 14 and the sign 18 to be deflected away from the second mast member 12b and the base 28 and, thus, away from the passenger compartment of the impacting motor vehicle. The breakaway beam 52 is, however, sufficiently strong so as to be able to withstand a substantial wind load exerted on the sign 18 over extended periods of time without premature failure.

The breakaway beam 52 is attached to the first mast member 12a by a pair of fourth bolts 54, extending through holes 62 in the breakaway beam 52, and corresponding nuts 56, and is attached to the second mast member 12b by a fifth bolt 58 and a corresponding nut 60. The breakaway beam 52 is preferably comprised of aluminum, or any sufficiently rigid material, and has a generally I-beam shaped cross section. The term “beam” is used in a broad sense to represent any type of disposed structural member, especially one with a length greater than its width or thickness, and the breakaway beam 52 may have any cross-sectional shapes, and is not limited to an I-beam shape. Moreover, the term beam is used in a broad sense to encompass other types of structural members including, but not limited to: angles, channels, tubes, rods, bars, pipes, posts, flats, brackets, or other similar structural members or supports, including hollow structures.

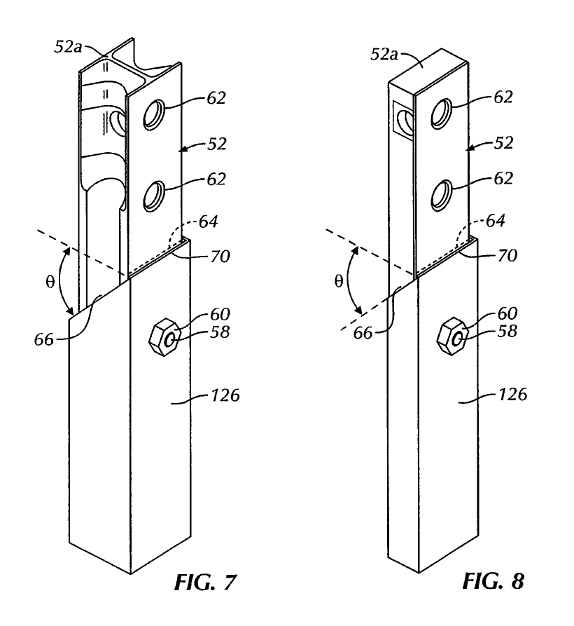

Referring to FIGS. 7 and 8, the breakaway beam 52 is preferably generally an I-beam-shape in cross section, although it is understood that breakaway beam 52 may have a cross-sectional shape that is square, rectangular, or circular, or have an H-shape, or a C-shape. The cross-section of the breakaway beam 52 may be hollow (e.g., tube-shaped), or solid. In sum, the breakaway beam 52 may have any cross-sectional size and shape so long as it can be used to join the mast 12. The holes 62 may extend partially into or completely through the breakaway beam 52 such that fourth and fifth bolts 54, 58 may secure the breakaway beam 52 to the mast 12. The fourth and fifth bolts 54, 58 may be threaded through the mast 12 into the breakaway beam 52 or alternatively mounted through the breakaway beam 52 and the mast 12 and secured with nuts 56, 60. The breakaway beam 52 is preferably secured to the mast 12 with bolts 54, 58 and corresponding nuts 56, 60, though it is understood that any type of fastener or securement could be used such as pins, screws, nails, rivets, staples, dowels, epoxy, cement, snap grooves, key-ways, threaded fittings, couplings, spring tension devices, welds, or the like. The breakaway beam 52 could have a generally hollow cross section and the mast 12 be substantially solid except where the breakaway beam 52 is inserted. Other variations and combinations of differing cross sections of the breakaway beam 52 may be used without departing from the spirit of the invention.

In the presently preferred embodiment, the breakaway beam 52 is formed or fashioned such that its outer dimensions are just slightly smaller than the inner dimensions of the mast 12. The breakaway beam 52 is inserted into the second mast member 12b and secured with the fifth bolt 58 and then the first mast member 12a would then be slid over the breakaway beam 52 and secured with fourth bolts 54. Alternatively, the breakaway beam 52 could be secured to the first mast member 12a and then secured to the second mast member 12a. It should be understood that the breakaway beam 52 could be formed as a bracket or socket instead and does not have to be completely concealed inside the mast 12.

The breakaway beam 52 may be formed of cast metal (such as steel, iron, or aluminum), extruded or molded plastic, fiberglass, wood, or other similar material that is capable of being broken clean through (fractured) upon impact, but the material must be strong enough to withstand normal static and wind loads without breaking or deforming. In the presently preferred embodiment, breakaway beam 52 is formed of cast metal of high hardness sufficient to break clean upon impact.

The mast 12 can be of any conventional material that is strong enough to be used for the described purpose, although preferably it is of a hollow metal construction, such as aluminum or steel. At present, hollow tubes made from extruded aluminum material have provided satisfactory results. The cross-sectional shape of the mast 12 is preferably square, although it is understood that the mast 12 may have any cross-sectional size and shape (e.g., rectangular or circular) so long as it can be used as a stand for a construction sign or similar display. The types of materials that are suitable for the mast 12 in a given application depend upon such factors as the size, shape, and weight of the sign 18, the length and width of the base 28, and other factors readily apparent to those skilled in the art.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

I/We claim:

1. A wind deflectable sign-stand, comprising:
a base;
a mast for mounting a sign; and
first and second resilient support members connecting the mast to the base, the support members comprising a polymer.

2. The sign-stand of claim 1, wherein the first and second support members are reinforced with fiberglass fibers extending along a longitudinal direction of the support members.

3. The sign-stand of claim 1, wherein the first and second support members each have a width and a thickness, and the width is substantially greater than the thickness.

4. The sign-stand of claim 1, wherein the sign-stand is configured such that the height of the sign is adjustable.

5. The sign-stand of claim 1, wherein the first and second support members are reinforced by third and fourth support members, respectively.

6. The sign stand of claim 1, wherein the first and second support members exhibit an increasing stiffness as the first and second support members are bent.

7. A sign-stand comprising:
first and second mast members; and
a breakaway member comprising a first end and a second end and being operably connected to the first and second mast members, wherein
the sign-stand is configured such that:
upon sufficient impact, the breakaway member will fracture, thereby separating the first end and the second end,
the separation of the first end and the second end occurs along a breakaway section of the breakaway member, and
the breakaway section defines a first acute angle with respect to a plane perpendicular to a longitudinal direction of the breakaway member.

8. The sign-stand of claim 7, wherein the first and second mast members are adjacent to one another along surfaces which are proximate to the breakaway section and which define a second acute angle with respect to the plane which is perpendicular to the longitudinal direction of the breakaway member, the first acute angle and the second acute angle being substantially the same.

9. The sign-stand of claim 7, wherein the first and second mast members adjoin one another along surfaces which are proximate to the breakaway section and which define a second acute angle with respect to the plane which is perpendicular to the longitudinal direction of the breakaway member, the first acute angle and the second acute angle being substantially the same.

10. The sign-stand of claim 7, wherein the first acute angle is about 45 degrees.

11. The sign-stand of claim 7, wherein the breakaway member comprises a generally rectangular beam of uniform cross-section, the first and second mast members have a generally rectangular and hollow cross-section, the first end of the breakaway member is disposed in the first mast member, the second end of the breakaway member is disposed in the second mast member, and the breakaway section is located between the first and second mast members.

12. The sign-stand of claim 7, wherein the breakaway member comprises a generally I-shaped beam, the first and second mast members have a generally square and hollow cross-section, the first end of the breakaway member is disposed in the first mast member, the second end of the breakaway member is disposed in the second mast member, and the breakaway section is located between the first and second mast members.
